(19) United States
(12) Patent Application Publication
(10) Pub. No.: US 2016/0308245 A1
(43) Pub. Date: Oct. 20, 2016

(54) COMPOSITION FOR HIGHLY CONDUCTIVE POLYMER ELECTROLYTES

(71) Applicant: DOW GLOBAL TECHNOLOGIES LLC, Midland, MI (US)

(72) Inventors: Jianping Xu, Shanghai (CN); Wei Li, Shanghai (CN); Yang Li, Shanghai (CN); Qingshan Niu, Shandong Province (CN); Ling Yuan, Shanghai (CN); Deidre A. Strand, San Diego, CA (US); Douglas A. Brune, Midland, MI (US)

(21) Appl. No.: 15/102,720

(22) PCT Filed: Dec. 11, 2013
(86) PCT No.: PCT/CN2013/089092

§ 371 Date: Jun. 8, 2016

(51) Int. Cl. H01M 10/0565; H01M 10/0525; C08L 71/02

(52) U.S. Cl. CPC H01M 10/0565; C08L 71/02; H01M 10/0525

(57) ABSTRACT

The present invention is directed to a composition containing a block copolymer, a metal ion and a specific oligomer which increases ion conductivity without decreasing mechanical strength of the composition. The composition is useful for a solid polymer electrolyte of a secondary battery.

### FIELD OF THE INVENTION

The present invention is directed to a composition for a polymer electrolyte for use in secondary batteries. In particular it is directed to a composition comprising a block copolymer and a specific oligomer which increases ion conductivity without decreasing mechanical strength of the composition.

### BACKGROUND OF THE INVENTION

Secondary batteries have been used as energy storage and power supply devices since the 1990s, especially for portable devices, like cell phones, notebook computers and power tools. Lithium ion batteries are widely used as secondary batteries because of their high energy density. The traditional lithium ion battery comprises a liquid electrolyte having lithium salts dissolved in an organic solvent, such as polar and aprotic carbonates.

However, the liquid electrolyte poses a risk of leaking of the organic solvent, which may result in explosions or fires. To address these problems, solid electrolytes have been developed as a possible alternative.

There are two types of solid polymer electrolyte, dry solid polymer electrolyte and gel polymer electrolyte. Dry solid polymer electrolyte has advantages like easy processing, low cost and flexible cell configuration, but its low ion conductivity makes it impractical.

In contrast to dry solid polymer electrolyte, gel polymer electrolyte has adequate ion conductivity, but its low mechanical strength is hindrance to a practical use. Therefore, it is highly desirable to develop a solid polymer electrolyte with both high ion conductivity and sufficient mechanical strength.

Many gel polymer electrolytes have been studied including polyalkylene oxide, polyvinylidene fluoride, polyacrylonitrile and polymethylmethacrylate based materials. A block copolymer comprising alkylene oxide chain is disclosed in U.S. Pat. No. 5,219,681; U.S. Pat. No. 5,424,150; U.S. Pat. No. 7,557,166 and US2012/0189910A. US2012/0189910A discloses the use of a block copolymer having two phases, a hard phase and an ion conductive phase. The ion conductive phase was formed by polyalkylene which provides satisfactory ion conductivity, as well as the hard phase works as a skeleton structure of the block copolymer which contributes high mechanical strength.

Inventors of this invention studied many kinds of chemicals and formulation to get more increased ion conductivity of the block copolymer type electrolyte without decreasing mechanical strength, and developed the composition of this invention.

### SUMMARY OF THE INVENTION

Inventors of this invention have found that when adding a specific oligomer in the block copolymer which has hard phase and ion conductive phase, its mechanical strength was not decreased while the ion conductivity was increased. The specific oligomer is an oligomer comprising both ethylene oxide and propylene oxide, and its weight average molecular weight (Mw) is less than 1,000. The contents of the oligomer are from 0.1 to 40 weight percent (wt %) based on a block copolymer.

Therefore, the one aspect of this invention is a composition comprising a block copolymer, a metal ion and 0.1 to 40 wt % of the specific oligomer. Another aspect of this invention is an electrolyte comprising the composition. Further aspect of this invention is a secondary battery comprising the electrolyte.

### DETAILED DESCRIPTION OF THE INVENTION

As used throughout this specification, the abbreviations given below have the following meanings, unless the context clearly indicates otherwise: Mw=weight average molecular weight; EO=ethylene oxide; PO=propylene oxide; wt % =weight percent; g =gram; mg =milligram; mm =millimeter; pm=micrometer; min.=minute(s); s =second(s); hr.=hour(s); ° C. =degree Centigrade; S/cm =simens per centimeter; Pa =pascal. Throughout this specification, the words “polyalkylene oxide”, “polyalkoxide” and “poly alkylene glycol” are used interchangeably. Throughout this specification, the words “ethylene oxide” and “ethylene glycol” are used interchangeably as well as the words “propylene oxide” and “propylene glycol”. Throughout this specification, the electrolyte which has hard phase and ion conductive phase is also called as “Hard Gel electrolyte”.

### Composition

The composition of this invention comprises a) a block copolymer, b) a metal ion and c) 0.1 to 40 wt % of specific oligomer.

### Block Copolymer

The block copolymer used in the inventive composition has both hard phase and ion conductive phase as disclosed in paragraph 0023 - 0046 of US2012/0189910A. Therefore, the disclosure of those sections of US2012/0189910A is incorporated by reference for describing the block copolymer used in the inventive composition. The block copolymer also called as “matrix polymer” in this specification. The hard phase of the block copolymer contributes mechanical properties of the composition. The ion conductive phase, which is also called as gel phase, contributes ion conductivity of the composition. The hard phase is mainly formed from a polymer block having a specific melting temperature or a glass transition temperature (hard component). The ion conductive phase is mainly formed from a block copolymer including a polyalkoxide. The block copolymer is preferably a graft copolymer.

The polymer block which mainly forms hard phase of the block copolymer has a glass transition temperature (measured for example according to ASTM E1640-99 using dynamic mechanical analysis) or a melting temperature (e.g., a maximum melting temperature or a peak melting temperature measured by differential scanning calorimetry (DSC)) or both greater than 50° C., preferably greater than 60° C., and most preferably greater than 70° C., even more preferably greater than 90° C. The polymer block of the block copolymer has a glass transition temperature, a melting temperature, or both that are less than 250° C., preferably less than 180° C., more preferably less than 160° C.

Examples of the monomer to form the polymer block which has the above final melting temperature or a glass transition temperature include; styrene, methyl methacrylate, isobutyl methacrylate, 4-methyl pentene-1, butylene terephthalate, ethylene terephthalate, and alpha-olefins such as ethylene and propylene. The polymer block of the block copolymer may be homopolymer or co-polymer polymerized from two or more of monomers.

The polymer block which mainly forms ion conductivity phase of the block copolymer includes a polyalkoxide. The polyalkoxide preferably include alkylene oxide having from 2 to 8 carbon atoms. Examples of the polyalkoxide include ethylene oxide, propylene oxide and copolymer thereof. More preferably, the polyalkoxide is a copolymer including ethylene oxide and propylene oxide.

The block copolymer may be prepared by grafting two or more of block polymers. Examples of a polymer block of hard phase include a copolymer of ethylene and acrylic acid such as PRIMACOR™ 3440 commercially available from The Dow Chemical Company. Examples of a block of polyalkoxide include a polyethylene oxide, polypropylene oxide and copolymer of ethylene oxide and propylene oxide all having one or more of terminal amine(s). Preferably, the block polymer which forms gel phase includes a copolymer of ethylene oxide and propylene oxide having one terminal amine such as Jeffamine M600 commercially available from Hunstman Corporation.

The method for preparing the block copolymer is shown in paragraphs 0047-0049 of US2012/0189910A and it is incorporated in this specification by reference. A typical example of the method for preparing the block copolymer includes the steps of;

mixing a copolymer of ethylene and acrylic acid and a copolymer of ethylene oxide and propylene oxide with one terminal amine group at 180° C. for 48 hours under a nitrogen atmosphere to make a grafted block copolymer, pouring the obtained solution into acetone and/or methanol, and washing the grafted block copolymer with methanol via a Soxhlet extractor for 2 days. The purification step (washing synthesized block copolymer via a Soxhlet extractor) is needed to remove excessive raw materials.

### Oligomer

The specific oligomer used in the composition comprises both ethylene oxide and propylene oxide with weight average molecular weight (Mw) is less than 1,000. The oligomer could be random co-oligomer or block co-oligomer of ethylene oxide and propylene oxide. If homo-oligomer of ethylene oxide or propylene oxide is used instead of the specific co-oligomer for the inventive composition, the mechanical strength of the obtained composition would be decreased. The mole ratio of ethylene oxide to propylene oxide of the oligomer is from about 1:10 to about 10:1.

The Mw of the oligomer used in the composition is less than 1,000. If an oligomer of its Mw is 1,000 or more is used, the ion conductivity of the obtained composition may not be increased.

Not being bound or limited in any way, the mechanism of the specific oligomer increasing ion conductivity of a composition without decreasing its mechanical strength is believed to be as follows: when the composition is used as an electrolyte, the alkylene oxide phase of the block copolymer will adsorb solvent and formed gel phase in the composition. This gel phase works as conductive pathway for the lithium ions. When adding the specific oligomer in the composition, the oligomer can be mixed with the gel phase and increase the alkylene oxide content of the composition. The higher the alkylene oxide content, the more pathways are formed for lithium ions and consequently the higher the ion conductivity. At the same time, the hard phase will remain continuous if the specific oligomer content is lower than a certain value. Thus the mechanical properties will remain unchanged. However, when adding a polyalkylene oxide excepting the specific oligomer in a composition for an electrolyte, the ion conductivity is decreased because the polyalkylene oxide are not ion conductive and thus it is necessary to have a higher content of the other polymers, resulting in less ion conductive pathways being formed for the lithium ions and hence lower ion conductivity.

The oligomer used in the composition preferably has an amino group. Not being bound by theory, but it seems that the lone pair of nitrogen atom and hydrogen atom of the oligomer are able to hydrogen bond (intermolecular bond), increasing the mechanical strength.

Examples of the oligomer used in the composition include, JEFFAMINE M-600 (600 of Mw copolymer of ethylene oxide (EO) and propylene oxide (PO), having one terminal amine group, PO/E0 mole ratio is 9/1) and JEFFAMINE HK-511, ED-600 and ED-900 (PO-EO-PO block co-oligomers with two terminal amines, Mw are 220, 600 and 900 respectively). Other examples of the oligomer used in the composition include, JEFFAMINE D230, D400, EDR-148, EDR-176, T-403 and XTJ-435 those have both ethylene oxide and propylene oxide within the molecule. Preferable oligomer is JEFFAMINE M-600.

The content of the oligomer is from 0.1 to 40 wt % based on the weight of the block copolymer used in the composition. If adding 50 wt % of oligomer within the composition, the mechanical strength would be decreased an undesirable amount. The content of the oligomer is preferably 0.5 wt % or more based on the weight of the block copolymer. The content of the oligomer is preferably 30 wt % or less, most preferably 20 wt % or less based on the weight of the block copolymer.

Preferably, oligomer used in the composition and the copolymer which forms ion conductive phase (gel phase) of the block copolymer used in the composition is same. When those two are same, the oligomer is easily mixed with gel phase of the block copolymer so that it contributes increasing ion conductivity of the composition. In addition, the process to prepare the composition of this invention becomes shorter because the purification step of the process can be obliterated.

### Metal Ion

The composition of the present invention comprises metal ion. Metal ion plays a role to carry a charge in the composition when the composition is used for an electrolyte. The metal ion can exist in the composition as a metal salt. A single salt or a mixture of two or more different salts may be used. Examples of metals of the metal ion include lithium, sodium, beryllium, magnesium or any combination thereof. A particularly preferable metal is lithium. Examples of metal salts include lithium bis-(trifluoromethanesulfonyl)-imide (Li-TFSI), lithium trifluoromethane sulfonate (lithium triflate or LiCF₃SO₃), lithium hexafluorophosphate (LiPF₆), lithium hexafluoroarsenate (LiAsF₆), lithium imide (Li(CF₃SO₂)₂N), lithium tris(trifluoromethane sulfonate) carbide (Li(CF₃SO₂)₃C), lithium tetrafluoroborate (LiBF₄), LiBF, LiBr, LiC₆H₅SO₃, LiCH₃SO₃, LiSbF₆, LiSCN, LiNbF₆, lithium perchlorate (LiClO₄), lithium aluminum chloride (LiA1Cl₄), LiB(CF₃)₄, LiBF(CF₃)₃, LiBF₂(CF₃)₂, LiBF₃(CF₃), LiB(C₂F₅)₄, LiBF(C₂F₅)₃, LiBF₂(C₂F₅)₂, LiBF₃(C₂F₅), LiB(CF₃SO₂)₄, LiBF(CF₃SO₂)₃, LiBF₂(CF₃SO₂)₂, LiBF₃(CF₃SO₂), LiB(C₂F₅SO₂)₄, LiBF(C₂F₅SO₂)₃, LiBF₂(C₂F₅SO₂)₂, LiBF₃(C₂F₅SO₂), LiC₄F₉SO₃, lithium trifluoromethanesulfonyl amide (LiTFSA), or any combination thereof. Combinations of lithium salts may also be used. Similarly, any of the above salts may also be combined with a different salt, such as a different metal salt.

The metal ion may be present at a concentration sufficiently high so that an electrolyte which comprises the composition demonstrates measurable conductivity. The concentration of metal ion in the composition is preferably 0.5 wt % or more, more preferably 1.0 wt % or more, and most preferably 1.5 wt % or more, based on the weight of the polyalkylene oxide phase of the matrix polymer, including the grafted polyalkylene oxide and the added polyalkylene oxide additive. The concentration of metal ion in the composition is preferably 30 wt % or less, more preferably 20 wt % or less, and most preferably 15 wt % or less, based on the weight of the polyalkylene oxide phase of the matrix polymer, including the grafted polyalkylene oxide and the added polyalkylene oxide additive.

The ratio of the molar concentration of oxygen atoms from the polymer block of gel phase of the block copolymer to the molar concentration of metal ions (O:M ratio) is determined. For lithium ion, the ratio is shown as O:Li ratio. Preferably the O:M ratio is 1:1 or more, more preferably 2:1 or more, even more preferably 4:1 or more, and most preferably 10:1 or more. Preferred O:M ratio is 120:1 or less, more preferably 80:1 or less, even more preferably 60:1 or less, even more preferably 40:1 or less, and most preferably 30:1 or less. By way of example, the O:M ratio of the composition may be about 10, about 15, about 20, or about 25.

### Solvent

The composition of the present invention may further comprise a solvent. The solvent is preferably an organic solvent. A preferred solvent includes cyclic carbonates, acyclic carbonates, fluorine containing carbonates, cyclic esters or any combination thereof. More preferably, the solvent is carbonates including cyclic, acyclic and fluorine containing carbonates or mixture thereof. Examples of such carbonates include ethylene carbonate (EC), propylene carbonate (PC), fluoroethylene carbonate (FEC), butylenes carbonate (BC), dimethyl carbonate (DMC), ethylmethyl carbonate (EMC), diethyl carbonate (DEC), dipropyl carbonate (DPC), methylpropyl carbonate (MPC), ethyl propyl carbonate (EPC), methylbutyl carbonate, vinylene carbonate (VC), vinylethylene carbonate (VEC), divinylethylene carbonate, phenylethylene carbonate, diphenylethylene carbonate, difluoroethylene carbonate (DFEC), bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate and any combination thereof. Among these solvents, EC and PC are preferred, and PC is the most preferred.

The concentration of the solvent including carbonates preferably 30 wt % or more, more preferably 35 wt % or more based on the total weight of the composition.

### Other Additives

The composition of the present invention may further comprise other additives. Examples of such additives include inorganic filler and ionic liquid. Inorganic filler increases the mechanical strength of the composition, and ionic liquid increases the ion conductivity of the composition. Examples of inorganic filler include SiO₂, ZrO₂, ZnO, CNT (carbon nanotube), TiO₂, CaCO₃, Al₂O₃ and B₂O₃. Examples of ionic liquid include 1-allyl-3-methylimidazolium chloride, tetraalkylammonium alkylphosphate, 1-ethyl-3-methylimidazolium propionate, 1-methyl-3-methylimidazolium formate and 1-propyl-3-methylimidazolium formate.

A typical example for the method of preparing the composition of this invention is; dissolving a block copolymer in toluene at 80° C., adding an oligomer in the toluene solution and mixing it at 80° C. for 30 minutes, pouring the mixture on polytetrafluoroethylene (PTFE) plate and removing toluene to form a solid membrane, immersing the solid membrane in a propylene carbonate (PC) solution with lithium ions, and incubating them for 6 hours.

### Electrolyte and Battery

The composition of this invention may be used as an electrolyte in a secondary battery cell including at least one anode, at least one cathode, one or more current collectors, and optionally a separator, all in a suitable housing. Especially, the composition of this invention may be used as a solid polymer electrolyte which has less risk of leakage of liquid electrolyte.

Also, the composition of this invention may be used as an electrolyte in a battery for providing power to an electrical device. The electrolyte comprising the composition may be advantageously used in a battery for providing power to a mobile device, such as a cell phone, a vehicle, a portable device for recording or playing sound or images such as a camera, a video camera, a portable music or video player, a portable computer and the like.

### EXAMPLES

### Inventive Examples 1 to 5

### Preparation of Block Copolymer (Matrix Polymer 1)

A graft copolymer having a copolymer of ethylene and acrylic acid (EAA) backbone and alkoxide grafts attached by an amide linkage was prepared by grafting Jeffamine M600 (available from HUNTSMAN CORPORATION) onto Primacor™ 3440 (available from THE DOW CHEMICAL COMPANY): 20 g of Primacor™ 3440 and 56.5 g of Jeffamine M600 were molten mixed at 180° C. under a nitrogen blanket by stirring for about 48 hours. The molar ratio of amine groups (—NH₂) to carboxylic acid groups (—COOH) was 3.5:1. Infra-red analysis of the reaction mixture indicated at least about 75 mole percent conversion of the acid to amide groups (acid C═O stretch at 1700 cm⁻¹ vs. amide C═O stretch at 1645 cm⁻¹). The melt was then poured into stirred methanol. The polymer was then cut into small pieces and washed with methanol via a Soxhlet extractor apparatus for 2 days. Next, the polymer was dried in vacuum overnight at about 70° C. The obtained polymer was pressed into a film and was characterized by FT-IR, DSC and proton NMR. The DSC indicated that the graft copolymer had a melting temperature of about 100° C. and a heat of fusion of about 31 J/g. The Proton NMR analysis was expected to indicate that the concentration of the ethylene oxide-propylene oxide grafts was about 40.1 weight percent based on the total weight of the graft copolymer. Comprehensive 2D NMR and ¹³C NMR were used for the signal assignments and the results indicated that the poly(ethylene oxide-co-propylene oxide) graft was attached to the EAA by an amide linkage. Newly formed amide proton in grafted polymer was presented at around 5.7 ppm. The grafted mole ratio was calculated according to divided the total carbonyl carbons at 176 ppm by amide branching carbon at 49 ppm in the 13C NMR spectrum. The calculation showed that about 76 mole percent of carboxylic acid in Primacor was converted to the amide by reacting with Jeff Amine.

The above prepared Matrix polymer 1 (10 g) was dissolved in 200 ml toluene at 80° C. 20 ml of the Matrix polymer 1 solution was then mixed with 0.05, 0.1, 0.2, 0.3 and 0.4 g of Jeff amine M600 (a copolymer of about 10 mole percent ethylene oxide and about 90 mole percent propylene oxide having one terminal amine group and one methyl ester group containing no alcohol groups, and has a weight average molecular weight (Mw) of about 600 g/mole, available from HUNTSMAN CORPORATION) at 80° C. for 30 minutes. The amounts of oligomer were 5, 10, 20, 30 and 40 wt % respectively based on the weight of Matrix polymer 1. The mixture was poured on PTFE plate and let the toluene dried for 10 hr at 80° C. to form a solid electrolyte membrane. The membrane was then dried at 80° C. in vacuum for further 48 hr. The membrane was cut into specimens with diameter of 18 mm. The samples were immersed in propylene carbonate with 1 M lithium bis-(trifluoromethanesulfonyl)-imide as lithium salts and incubated for 6 hr. The obtained polymer electrolytes were ready of performance evaluation. Results are shown in Table 1.

### Test Methods

### 1. Ion Conductivity

The ion conductivity of the polymeric electrolyte compositions was measured using AC impedance spectroscopy in Princeton 2273 using alternating current (AC) amplitude of about 10 mV. Details of the AC impedance spectroscopy method are in Handbook of Batteries, 3rd Ed; David Linden and Thomas Reddy, Editors, McGraw-Hill, 2001, New York, N.Y., pp.2.26-2.29, incorporated herein by reference.

### 2. Storage modulus (G′)

Storage modulus is used to characterize the mechanical strength of an electrolyte. Storage modulus of the polymers and of the polymeric electrolyte compositions were measured using dynamic mechanical analysis (e.g., according to ASTM D5279-08). Unless otherwise specified shear modulus is measured at a temperature of about 30° C. and a oscillatory shear frequency of about 1 radian/sec at a strain of typically about 0.04 percent.

TABLE 1
Inventive Examples

| | | | Ion | Mechanical |
|---|---|---|---|---|
| | | Amount | conductivity | strength |
| No. | Oligomer | (%) | (×10⁴, S/cm) | (×10⁶, Pa) |
| 1 | Jeffamine M600 | 5 | 4.03 | 2.20 |
| 2 | Jeffamine M600 | 10 | 4.35 | 2.28 |
| 3 | Jeffamine M600 | 20 | 5.68 | 2.31 |
| 4 | Jeffamine M600 | 30 | 6.60 | 1.23 |
| 5 | Jeffamine M600 | 40 | 6.60 | 1.09 |

### Comparative Examples 1 to 6

Comparative examples 1 to 6 were conducted same as Inventive Example 1 except that the oligomer and its amount of Inventive Example 1 was changed as shown in

Table 2 and 3. The results are shown in Table 3.

TABLE 2
Additive and its structure of Comparative Examples

| No. | Oligomer or polymer | Structure |
|---|---|---|
| 1 | None | — |
| 2 | Jeffamine M1000 | A copolymer of about 10 mole percent |
| | (available from | ethylene oxide and about 90 mole |
| | HUNSTMAN | percent propylene oxide having one |
| | CORPORATION) | terminal amine group and one methyl |
| | | ester group, Mw is about 1,000 |
| 3 | Pluronics F127 (available | a copolymer of ethylene oxide and |
| | from BASF Company) | propylene oxide with the molecule |
| | | structure of PEO100-PPO65-PEO100 |
| 4 | Jeffamine M2070 | a copolymer of about 75.6 mole percent |
| | (available from | ethylene oxide and about 24.4 mole |
| | HUNSTMAN | percent propylene oxide having one |
| | CORPORATION) | terminal amine group and one methyl |
| | | ester group, Mw is about 2,000 g/mole |
| 5 | PEG400 (available from | polymer of ethylene oxide, with |
| | Sigma Company) | molecule weight of 400 |

TABLE 3
Comparative Examples

| | | | Ion | Mechanical |
|---|---|---|---|---|
| | Oligomer or | Amount | conductivity | strength (×10⁶, |
| No. | polymer | (%) | (×10⁴, S/cm) | Pa) |
| 1 | —*¹ | — | 2.47 | 2.09 |
| 2 | Jeffamine M1000 | 20 | 1.83 | —*² |
| 3 | Pluronics F127 | 20 | 2.02 | —*² |
| 4 | Jeffamine M2070 | 20 | 3.01 | —*² |
| 5 | PEG400 | 20 | 7.80 | 0.17 |
| 6 | Jeffamine M600 | 50 | 6.94 | 0.50 |

*¹Comparative Example 1 was not added any oligomer or polymer.
*²Mechanical strength of Comparative Examples 2-4 were not measured because Ion conductivity of those examples was bad.

### Inventive Example 6

### Preparation of Block Copolymer Mixture (Matrix Polymer 2)

A block copolymer mixture is prepared same as Inventive Example 1 except that the process of washing it with methanol via a Soxhlet extractor apparatus was not conducted. The obtained block copolymer mixture contained about 8% of free Jeffamine M600 based on the weight of block copolymer.

Same procedure was conducted as for Inventive Example 1 except that the oligomer (Jeffamine M600) was not added. The ion conductivity of the obtained electrolyte was 4.20×10⁴ S/cm, and G′ was 2.24×10⁶ Pa.

### Comparative Example 6

Same procedure was conducted as for Inventive Example 1 except that 50% of Jeffamine M 600 was added. The ion conductivity of the obtained electrolyte was 6.94×10⁴ S/cm, and G′ was 0.50×10⁶ Pa.

1. A composition comprising
a) a block copolymer comprising
i) a polymer block having a final melting temperature greater than 60° C. or a glass transition temperature greater than 60° C., and
ii) a polymer block including a polyalkoxide;
b) a metal ion; and
c) 0.1 to 40 weight percent of an oligomer based on the block copolymer, the oligomer comprises ethylene oxide and propylene oxide in the structure, the weight average molecular weight of the oligomer is less than 1,000.

2. The composition of claim 1, wherein the oligomer further comprises an amino group.

3. The composition of claim 1, wherein the polyalkoxide of the polymer block of the block copolymer comprises ethylene oxide and propylene oxide.

4. The composition of claim 1, wherein the metal ion is lithium ion.

5. The composition of claim 1, wherein the composition further comprises carbonates.

6. A solid polymer electrolyte comprising the composition of claims 1.

7. A secondary battery comprising the solid polymer electrolyte of claim 6.
